(19) United States
(12) Patent Application Publication
(10) Pub. No.: US 2025/0035437 A1
(43) Pub. Date: Jan. 30, 2025

(54) THZ MEASURING METHOD AND THZ MEASURING DEVICE FOR MEASURING A JOINT OF A CONTAINER

(71) Applicant: CiTEX Holding GmbH, Melle (DE)

(72) Inventors: Jan Hendrik BECKMANN, Melle (DE); Markus HILDEBRANDT, Bad Oeynhausen (DE)

(21) Appl. No.: 18/782,387

(22) Filed: Jul. 24, 2024

(30) Foreign Application Priority Data
Jul. 26, 2023 (DE) 10 2023 119 780.0

(51) Int. Cl. G01B 15/02; B25J 15/00

(52) U.S. Cl. CPC G01B 15/02; B25J 15/0019

(57) ABSTRACT

A THz measuring method and a THz device for measuring a container with a joint, in particular, a blow mold container with a pinch-off seam, where a THZ sensor is adjusted relative to a container region in multiple positions with different orientations of the optical axis, THz radiation is emitted as a non-parallel beam bundle from the THz sensor towards the container region, and THz radiation partially reflected on the interior surface and the exterior surface of the container area is received, and one or more of the characteristics of the joint are determined.

### PRIORITY CLAIM

This application claims priority to German Patent Application No. DE 10 2023 119 780.0, filed Jul. 26, 2023, which is expressly incorporated by reference herein.

### BACKGROUND

The present disclosure relates to a THz measuring method and a THz measuring device for measuring a container with a joint, in particular, a blow mold container with a pinch-off seam.

### SUMMARY

It is an object of the present disclosure to create a THz measuring method and a THz measuring device for measuring a container with joints allowing for a secure measurement with relatively little effort.

This task is solved by a THz measuring method and a THz measuring device according to the independent claims. Preferred further developments are described in the sub-claims. Further, a method for manufacturing and measuring a blow mold container is provided. The measuring method according to the present disclosure may be carried out, in particular, using the measuring device according to the present disclosure.

Thus, according to the present disclosure, at least one THz sensor, which may also be, in particular, a radar sensor, is adjusted relative to the container area to be examined, in particular, the end region of the blow-form container, so that a plurality of data sets is obtained from this examination consisting of, in particular, the measuring signals of the sensor, the respective position of the sensor relative to the container region, as well as the orientation of the optical axis of the sensor relative to the container region.

Subsequently, these data sets, preferably representing data tuples containing the respective position data, orientation data and measuring signals of the THz sensor, and optionally even further data, can be used to evaluate the joint, whereby, in particular, the following relevant characteristics of the joint are determined:
a length of the joint along its longitudinal direction,
a layer thickness profile of the joint, in particular, perpendicular to the joint and/or along the joint,
a width of the joint in a transverse direction perpendicular to its longitudinal direction,
a ripple wall thickness of at least one ripple formed at an interior surface,
a residual wall thickness in an indentation between two ripples,
a joint angle of the joint on the interior surface in an indentation between two ripples.

The present disclosure recognizes, in particular, that the joint may be shaped towards the interior surface like a kissing mouth, with two areas of larger layer thickness, in particular, wave-shaped areas of larger layer thickness, and an indentation lying in between. In principle, such a kissing mouth-shaped formation can be recognized as correct, provided that the layer thickness is sufficiently large and the indentation creates a not too acute angle because under mechanical load and, in particular, under pressure asymmetrical forces, in particular, shearing forces from the inside may occur, which will stress the joint to such an extent that the seam may become damaged, weakened or even undone. Thus, e.g., a pressure acting from the inside on an indentation with a too acute angle may exert tension stress on the seam in this area or, respectively exert shearing forces, to such an extent that rupturing and destruction of the seam may be initiated.

Thus, various advantages are attained. Thus, a measurement can be carried out with relatively little effort because here, in particular, the relative position of the container area and of the sensor are to be adjusted, with a pre-defined relative adjustment. This recognizes the fact that such relative adjustment can be carried out using pre-programmed data, and this is possible with relatively little effort. The relative adjustment can be carried out in a number of ways. It is advantageous, in particular, to adjust the THz sensors relative to the fixed container because for this the container is firmly received in a receiving means and the sensor is adjusted in relation there to in a pre-defined manner, e.g., by means of a robotic arm guiding the sensor along a pre-defined path, while continuously measuring is carried out by the THz sensor. In particular, such an embodiment with a robotic arm allows for a quick and secure guiding with various positions and various orientations of the optical axis of the THz sensor.

In principle, it is possible to adjust only one THz sensor; further, however, it is also possible to adjust multiple THz sensors at the same time thereby allowing for a quicker examination.

In an alternative, measurements are also possible involving, e.g., the adjustment of the sensor in a rail. Further, it is also possible to adjust the container relative to the sensor in that the adjustment means adjusts the container region relative to a fixed sensor arrangement. The fixed sensor arrangement may be formed, in particular, including multiple sensors which have, e.g., different orientations.

According to a particularly preferred embodiment, the THz sensor puts out non-parallel radiation, in particular, divergent or convergent radiation, i.e. with an opening angle of the beam bundle. Hereby, the emission of divergent radiation, i.e. a cone of rays widening towards the outside, is of particular advantage. The enables the emission of beams leading to a reflection at points of the boundary surfaces that are not in a perpendicular orientation in relation to the optical axis of the THz sensor. Thereby, reflections from various points of the joint can be detected, e.g., even from measuring positions having a smaller angle of incidence where the THz sensor will detect no reflections of the exterior surface. In general, it will not to be possible to directly associate the reflections of the cone of beams with a boundary surface from the individual measurements, where, e.g., even multiple different points of the pinch-off seam may reflect simultaneously. However, the present disclosure recognizes that the large number of measurements at the various positions at different orientations later allows for a secure determination.

According to a preferred embodiment, the determination can be made according to the principle of synthetic radar aperture SAR which is otherwise determined from height measurements in aircraft. Such SAR determinations are made, in particular, from flying objects like aircraft or satellites and allows for a two-dimensional imaging of a segment of terrain. The present disclosure recognizes that such an evaluation method, used in terrain measurements by aircraft, in the present case is also advantageous for measuring a pinch-off seam.

Further methods of evaluating the pinch-off seam are neural networks or deep learning, further, artificial intelligence (AI). Hereby, in particular, it is possible to initially carried out measurements of correct pinch-off seams, and further measurements of incorrect pinch-off seams, so that the extensive data sets can be used in a learning process to determine or learn which joints are to be evaluated as correct and as incorrect.

Thus, a container can be measured in that an, e.g., essentially cylindrical, container is first positioned in a receptacle such that its end region lies exposed for being measured, and the measurement is carried out covering the area of the joint in that a THz sensor or multiple THz sensors are guided across the joint in trajectories, in particular, in three dimensions or, respectively, not merely in a single measuring plane, and the so obtained data sets are evaluated so that an evaluation in the form of an error signal as “correct-incorrect” is put out.

Hereby, one or more of the following comparisons may be carried out: comparing the layer thickness of the ripple or of the two ripples with a lower threshold value and/or an upper threshold value,
comparing the layer thickness of the indentation with a lower threshold value,
comparing the indentation layer thickness with a container layer thickness in the region outside the pinch-off seam,
evaluating the joint opening angle or seam angle respectively in relation to a lower threshold value, to detect acute-angled edges formed in-between the ripples that may lead to undue loads.

Thus, it is possible to perform a versatile measurement with little effort, which also can be continuously improved in a self-learning procedure.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows the measurement of a container bottom with a pinch-off seam using a THz measuring device according to an embodiment;

FIG. 2 is a bottom view of the container from FIG. 1 with the pinch-off seam;

FIG. 3 shows a section through a correct pinch-off seam; and

FIG. 4 shows a section through an incorrect pinch-off seam.

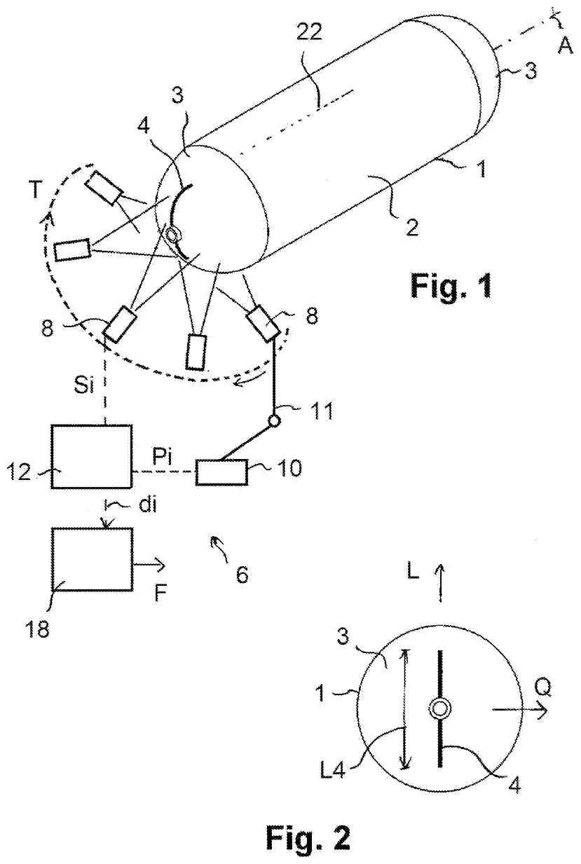

### DETAILED DESCRIPTION

FIG. 1 shows a container 1 made of plastic forming, e.g., a, inner liner for a hydrogen tank. The container 1 comprises, e.g., a cylindrical middle part 2 and two rounded-off end regions 3. In each of the end regions 3 a pinch-off seam 4 is formed which extends generally along a longitudinal direction L. The end region 3 with the pinch-off seam 4 is measured by means of a THz measuring device 6 which includes: one or more adjustable THz sensors 8, an adjustment means 10 which in this case comprises an articulated robotic arm 11 for adjusting the THz sensor 8 along a trajectory T, a controller means 12, and an evaluation unit 18. Thus, in FIG. 1, a single THz sensor 8 is adjusted along the trajectory T in different positions Pi with different orientations Oi of its optical axis B. In particular, the THz sensor 8 carries out measurements continuously during the adjustment. In particular, the trajectory is shaped not merely circular with an orientation of the optical axis B of the sensor 8 towards a constant center point, but rather in such a way that the pinch-off seam 4 is measured from different positions and directions. Hereby, preferably, a trajectory is formed that extends not only in one measuring plane but forms a three-dimensional path; the THz sensor 8 may, e.g., be guided across the pinch-off seam 4 multiple times. In the schematic representation of FIG. 1, the THz sensor 8 is depicted significantly smaller than the container 1; however, it is also possible to adjust a larger THz sensor 8.

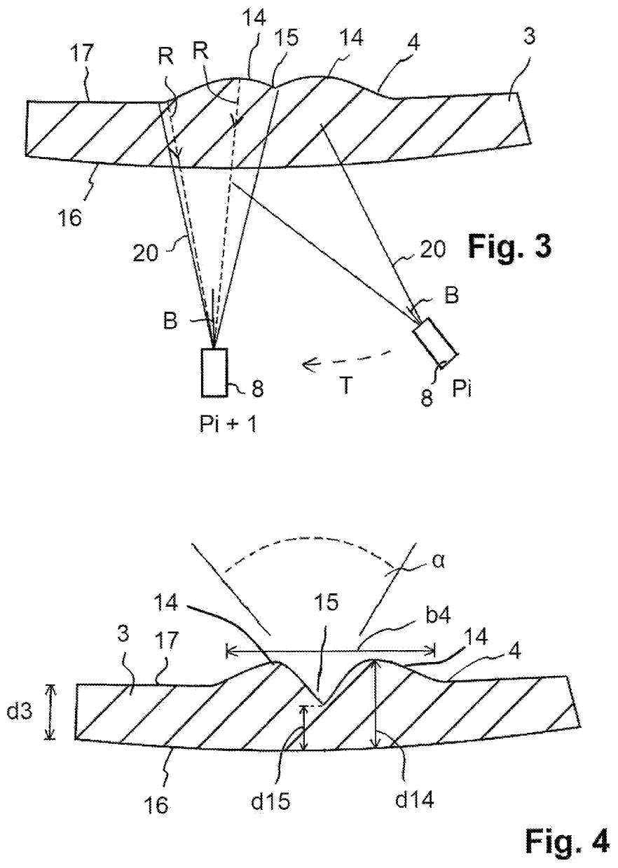

The container 2 is manufactured by means of a blow mold process, in particular, a blow mold extrusion process, in which the end regions 3 are formed by block molding. To that end, e.g., a plastics granulate, e.g., a polyamide or a polyethylene, is used as a starting material and melted and extruded via an annular gap so that a tube of melt of the molten plastics material is discharged, e.g., continuously or with temporary interruptions. Them for the purpose of shaping the container 2, the tube of melt is received in an exterior mold, inflated from within and pressed against the exterior mold von. Subsequently, the end regions 3 are formed in that two mold blocks each are closed from outside towards the inside, thereby forming the, e.g., semi-round end regions 3, and squeeze off the tube of melt. In the middle region of the end regions 3, where the mold blocks meet and squeeze off the tube of melt, the pinch-off seam 4 is formed as shown, by way of example, in the sectional representations of FIGS. 3 and 4.

The container 1 may be, in particular, an inner liner for a hydrogen tank, as used more and more in hydrogen technologies, e.g., in hydrogen operated vehicles and busses or in transport. The inner liner should be subsequently be reinforced, e.g., by wrapping around with carbon fiber mats; in principles, however, the container 1 is already needed to exhibit a high degree of hydrogen impermeability and pressure resistance. As plastics material, in particular, a polyamide or polyethylene my be chosen which is sufficiently hydrogen tight and can be formed by a blow molding process.

FIG. 3 shows a correct pinch-off seam 4 in the end region 3, where FIG. 3 shows the exterior surface 16 of the end region 3 at the bottom and the interior surface 17 at the top. Thus, the pinch-off seam 4 is formed essentially inwards, i.e., towards the interior of the container, so that generally its shape cannot or not clearly be viewed from the outside, and measuring from the outside is also difficult. In the area where the clamping jaws or mold blocks respectively are pressed together, the pinch-off seam 4 is formed and creates a kissing mouth-like shape with typically two ripples 14 and an indentation 15 formed in-between the ripples. According to FIG. 3, the ripples 14 lead to a thickening of the cross-section so that a wall thickness d increases; thus, the end region 3 or container bottom respectively forms an end region-wall thickness d3 outside the pinch-off seam 4, in each of the ripples 14 a ripple wall thickness d14, and in the indentation 15 a residual wall thickness d15.

The values relevant in measuring the pinch-off seam are shown, in particular, in FIG. 4. In the correct pinch-off seam 4 of FIG. 3, the ripple wall thickness d14 is larger than the end region wall thickness d3 and forms, in particular, a maximum value of the wall thickness d, and also the residual wall thickness d15 in the indentation 15 is larger than the end region wall thickness d3 so that the pinch-off seam 4 at first represents no weakening of the end region 3. Further, the indentation 15 forms an obtuse joint angle alpha between the ripples 14, in particular, a joint angle alpha above a threshold value alpha_th, so that in the closed container 1 even under load from the inside caused by high internal pressure the forces occurring or, respectively, shearing forces in the bottom region 3 will not lead to ruptures.

FIG. 4 shows an incorrect pinch-off seam 4, in which, for one thing, the indentation 15 runs deeper so that, e.g., the residual wall thickness d15 lies below a threshold value d15_th which is determined, e.g., by the value of the end region-wall thickness d3. Further, a weakening of the end region 3 is formed in that the indentation 15 forms a joint angle alpha on the interior surface 17 of the end region 3 which is more acute compared to FIG. 3 which lies, e.g., below a threshold value alpha_th. Thus, in case of a load of high interior pressure, rupturing may occur in the region of the indentation 15 because the interior pressure generates shearing forces on the inclined surfaces of the ripples 14 that may subject the indentation 15 to tension. Both the small residual wall thickness d15 as well as the large joint angle alpha represent faults which lead to an error signal F upon being detected by the evaluation unit 18

Measuring the wall thickness d in the cylindrical area 2 can be carried out using a THz measuring method for measuring strands and cylindrical objects because the cylindrical wall is shaped—ideally—concentrical to a middle axis A allowing for THz sensors to be oriented perpendicular onto the axis. Thus, THz radiation is reflected on layer boundaries, in this case the exterior surface 16 and interior surface 17 of the cylindrical middle area 2, so that the wall thicknesses can be determined from the THz measuring signals. It is not possible to make a measurement of the pinch-off seam 4 using such a method with a time-of-flight measurement, in which reflection peaks from the interior surface 17 and exterior surface 16 are determined in a THz measuring signal with the distance between these two reflection peaks representing the layer thickness, because the interior surface 17 of the pinch-off seam 4 is not defined and running parallel to the exterior surface. Thus, e.g., in FIG. 3 and FIG. 4, while it is possible to arrange a THz sensor 8 from below perpendicular to the exterior surface 16, i.e. the underside of the container bottom; however, THz radiation 8 irradiated here to perpendicularly will usually be laterally reflected away on the ripples 14 and the indentation 15.

According to the present disclosure, a detailed measurement of the pinch-off seam 4 is carried out by the THz measuring device 6 shown in FIG. 1, where
for one thing, the at least one THz sensor 8 exhibits a suitable emission cone 20 of the THz radiation 19, in particular, as shown in FIGS. 1, 3 and 4, as a divergent emission cone 20, and
for another, the adjustment device 10, i.e., in this case the robotic arm 11, adjusts the THz sensor 8 along the pre-defined trajectory T into the pre-defined measuring positions Pi. Thus, e.g., even positions like the right-hand position Pi of FIG. 3 are assumed in which the optical axis B is directed not perpendicular towards the exterior surface 16 but the pinch-off seam 4 is covered by the emission cone 20. FIG. 3 indicates the adjustment from the position Pi into the position Pi+1.

In each measurement the THz sensor 8 is only capable of detecting THz radiation R reflected back perpendicularly. As shown in FIG. 4, the divergent emission cone 20 allows the scanning of different areas not lying inside the respective optical axis B of the THz sensor 8. Thus, the THz sensor 8 detects measuring signals Si which, taken individually, do not yet allow for a representation of the pinch-off seam 4 according to FIG. 3 or FIG. 4. However, the large number of measurements of the THz sensor 8, taking into account both the emission characteristics as well as the position and angular orientation along the trajectory T, allows for a subsequent model creation.

The at least one THz sensor 8 puts out its measuring signals Si to the controller means 12 which also controls the adjustment means 10 and sets the respective positions Pi of the THz sensor 8 along the trajectory T. This allows the measuring signals Si to be assigned to the respective position data Pi of the THz sensor 8 along the trajectory T.

By virtue of the fact that the adjustment means 10 is provided with a robotic arm 11 it is possible to adjust a large number of positions Pi and angular orientations or, respectively, orientations of the THz sensor 8 according to the pre-specified data, in particular, with continuous adjustment and detection of the measuring signals Si. Thus, it is possible—in contrast to an adjustment on a fixed circular path or track respectively—to scan the pinch-off seam 4 from different angles and distances to the container end region 3 or container bottom respectively.

Alternatively, e.g., the THz sensors 8 may also be guided along a rail. Furthermore, the relative adjustment between THz sensor 8 and container end region 3 may also be carried out by adjusting the container end region 3 with a fixed or even a movable arrangement of the THz sensor 8, e.g., with a large number of THz sensors 8 at different positions. Furthermore, even combined adjustments of container 1 and THz sensor 8 are possible.

The controller means 12 subsequently puts out data sets di from the measuring signals Si and position signals Pi associated there with, including the orientation, to the evaluation unit 18 which evaluates these data and there from determines the relevant values of the pinch-off seam 4. Hereby, the pinch-off seam 4 is evaluated in its longitudinal direction L and transverse direction, where the shape of the ripples 14 and of the indentation 15 is evaluated and, e.g., the values d3, d15, d14, alpha, b4 are determined and compared with threshold values.

In this evaluation by the evaluation unit 18, in particular, a synthetic radar aperture (SAR) may be used. Such SAR determinations are carried out, in particular, from flying objects like aircraft or satellites and allow for a two-dimensional representation of a terrain segment. Thus, a model M is generated which will then be evaluated. Furthermore, e.g., a neural network, deep learning or, respectively, artificial intelligence may be employed.

Thus, a large number of data is collected, with none of the measurements alone allowing for a further evaluation; however, by using the measuring data along the trajectory T a modeling or evaluation of the pinch-off seam 4 can be carried out subsequently, e.g., by means of SAR. In the case of the SAR measurement the THz sensor 8 in each case emits sufficiently large emission cones 20 so that the emission cones 20 from the various measuring positions overlap. Since the measuring positions Pi of the THz sensor 8 are known, in particular, in the case of an adjustment direction (azimuth direction) past the measured object, the measured images are superimposed at known positions Pi. Thus, the target area of the object is irradiated with a changing viewing angle and detected accordingly. The aperture of a large antenna can be synthetized from the intensity and preferably phase position of the received radar echoes, i.e. the reflected beams R, thereby attaining of high spatial definition and motion direction of the antenna. Hereby, the individual amplitudes and phase positions can be interconnected by means of a radar signal processor in the evaluation unit 18 in such a way that a large image as a virtual model, e.g., as an elevation profile of the pinch-off seam 4 and the container bottom 3, is synthetized. Using the SAR evaluation algorithms, it is also possible to correct the phases of the received signals, where even time of flight differences between individual antenna positions can be corrected thus taking the trigonometric conditions under consideration. Hereby, time of flight differences can be measured as phase differences.

According to further embodiments, a self-learning method, in particular, an artificial intelligence (AI) and/or a neural network may be used. In the case of neural networks good/bad criteria can be taught in, and these may be used in evaluating the spatial and temporal signal path of the signals.

Thus, the following information relating to the container bottom 3 can be determined:

The wall thickness progression and wall thickness in the area of the indentation 15 and the ripples 14, e.g., as a layer thickness profile Sp, furthermore, the joint angle alpha, the wall thicknesses d3, d14, d15, the width b4 and length LA of the pinch-off seam 4.

Der THz sensor 8 may emit and detect, in particular, THz radiation in a frequency range between 10 GHZ and 50 THz, in particular, 10 GHZ and 10 THZ, in particular, 20 GHz, or between 50 and 5 THz, preferably 50 GHz and 5 THz. The THz radiation may be emitted as frequency modulated radiation, in particular, FMCW-radar (frequency modulated continuous wave radar) or continuous or temporarily interrupted radiation, e.g., even pulsed THz radiation or in the form of pulses respectively.

As an alternative to the above-shown divergent beam characteristics, it is also possible to use a focused beam characteristics, which also allows for a non-parallel beam cone 20 to be formed.

Furthermore, it is also possible to measure a form closure joint 22 on the container 1 or an extruded container on a middle area, e.g., the cylindrical area 2. The form closure joint 22 is created in in the area where the tube of melt, inflated from the inside, gets into the border area between the halves of the form and may exhibit an irregularity because of this. Such form closure joints 22, too, can be measured accordingly.

The present disclosure relates to a THz measuring method and a THz measuring device for measuring a container with a joint, in particular, a blow mold container with a pinch-off seam.

Containers made from plastic materials may be manufactured using blow mold processes in that initially a tube of melt from a plastic material is extruded, the extruded tube of melt is aligned using a stream of air and seized by a pair of mold blocks and compressed. By means of the mold blocks an, e.g., cylindrical central region is formed, and, moreover, the tube is compressed and squeezed off at one or both end regions so that an enclosed end region with a pinch-off seam is created here. The pinch-off seam is formed, in particular, on the inner surface of the container and will generally exhibit a characteristic cross-sectional shape leading to a local swelling of the material with a central indentation at the joint.

Accordingly, the quality of the pinch-off seam will depend on the respective production conditions. Thus, e.g., the wall thickness may be too thin or have an undefined or problematic shape at the entire joint or even at parts of the joint, and this may lead to ruptures or defects occurring in the product in the event of mechanical stress or under pressure. Thus, blow mold containers are also used in safety-relevant components such as LNG or hydrogen liners of gas cylinders some of which will be filled under high pressure and with flammable materials like hydrogen or natural gas.

Generally, the pinch-off seam is evaluated only visually by the user or by means of a camera. Hereby, it is a problem that the pinch-off seam usually appears relatively smooth on the outside and the specific shape with the ripples and the indentation will be formed towards the inside making it hard or even impossible to be seen from outside, in particular, in the case of non-transparent plastic materials.

Comparative methods for determining wall thicknesses of plastic containers, e.g., using THz or radar radiation, are generally suitable for detecting layer thicknesses of parallel boundary surfaces; in the event of non-parallel boundary surfaces however, the beam will usually be reflected at boundary surfaces one of the laterally to one side making it impossible to capture. This is generally recognized as a fault in comparative inspections of tubular bodies. However, in the case of a pinch-off seam a non-parallel formation, in particular, of the interior surface, is to be considered proper as long as the layer thickness is not too narrow and the shape as such is not a problem.

One comparative method for inspecting the wall thickness of container made of at least partially transparent material, wherein light is emitted from a glowing spiral or a glow filament in the infrared to white range as emission spectrum according to the temperature and impacts the wall of a container, whereupon an optical detector in the form of a camera detects the light reflected from the container and/or transmitted.

For evaluating the measurement curve it is possible to correlate a reference curve of a known, second characteristic with the measurement result, where, in a plastic container, this may be the container joint or the bottom which is in a fixed angular relationship to the elements to be measured.

Another comparative THz measuring device and a THz measuring method for measuring a wall thickness of a tubular measurement object, where a main THz sensor and an auxiliary THz sensor are positioned at various positions around the tubular measurement object to detect um wall thickness deformations, e.g., eccentricities, as reflections.

Another comparative method for manufacturing plastic hollow bodies by blow-molding a preform with a wall profile changing along a longitudinal direction is made from a plastic melt, and subsequently formed in a blow-molding process into a plastic hollow body, where its wall thickness is measured for regulating purposes.

Another comparative method and a comparative device for controlling a production facility for plate-shaped or strand-shaped bodies, wherein the body is transported along a transport direction through a measuring area, wherein the body is irradiated in the measuring area using measuring radiation in the Gigahertz or Terahertz frequency range and the measuring radiation penetrated the body, at least in part, where measuring radiation reflected from the body is detected and the refractive index of the body and/or the absorption by the body is determined.

Another comparative device and method for a non-destructive, contactless measuring of composite structures by means of Terahertz waves, where tomographic information of composite structures is detected with high precision using a three-dimensional, adjustable multi-articular robot.

Thus, it is the object of the present disclosure to create a THz measuring method and a THz measuring device for measuring a container with joints allowing for a secure measurement with relatively little effort.

This task is solved by a THz measuring method and a THz measuring device according to the independent claims. Preferred further developments are described in the sub-claims. Further, a method for manufacturing and measuring a blow mold container is provided. The measuring method according to the present disclosure may be carried out, in particular, using the measuring device according to the present disclosure.

Thus, according to the present disclosure, at least one THz sensor, which may also be, in particular, a radar sensor, is adjusted relative to the container area to be examined, in particular, the end region of the blow-form container, so that a plurality of data sets is obtained from this examination consisting of, in particular, the measuring signals of the sensor, the respective position of the sensor relative to the container region, as well as the orientation of the optical axis of the sensor relative to the container region.

Subsequently, these data sets, preferably representing data tuples containing the respective position data, orientation data and measuring signals of the THz sensor, and optionally even further data, can be used to evaluate the joint, whereby, in particular, the following relevant characteristics of the joint are determined:
a length of the joint along its longitudinal direction,
a layer thickness profile of the joint, in particular, perpendicular to the joint and/or along the joint,
a width of the joint in a transverse direction perpendicular to its longitudinal direction,
a ripple wall thickness of at least one ripple formed at an interior surface,
a residual wall thickness in an indentation between two ripples,
a joint angle of the joint on the interior surface in an indentation between two ripples.

The present disclosure recognizes, in particular, that the joint may be shaped towards the interior surface like a kissing mouth, with two areas of larger layer thickness, in particular, wave-shaped areas of larger layer thickness, and an indentation lying in between. In principle, such a kissing mouth-shaped formation can be recognized as correct, provided that the layer thickness is sufficiently large and the indentation creates a not too acute angle because under mechanical load and, in particular, under pressure asymmetrical forces, in particular, shearing forces from the inside may occur, which will stress the joint to such an extent that the seam may become damaged, weakened or even undone. Thus, e.g., a pressure acting from the inside on an indentation with a too acute angle may exert tension stress on the seam in this area or, respectively exert shearing forces, to such an extent that rupturing and destruction of the seam may be initiated.

Thus, various advantages are attained. Thus, a measurement can be carried out with relatively little effort because here, in particular, the relative position of the container area and of the sensor are to be adjusted, with a pre-defined relative adjustment. This recognizes the fact that such relative adjustment can be carried out using pre-programmed data, and this is possible with relatively little effort. The relative adjustment can be carried out in a number of ways. It is advantageous, in particular, to adjust the THz sensors relative to the fixed container because for this the container is firmly received in a receiving means and the sensor is adjusted in relation there to in a pre-defined manner, e.g., by means of a robotic arm guiding the sensor along a pre-defined path, while continuously measuring is carried out by the THz sensor. In particular, such an embodiment with a robotic arm allows for a quick and secure guiding with various positions and various orientations of the optical axis of the THz sensor.

In principle, it is possible to adjust only one THz sensor; further, however, it is also possible to adjust multiple THz sensors at the same time thereby allowing for a quicker examination.

In an alternative, measurements are also possible involving, e.g., the adjustment of the sensor in a rail. Further, it is also possible to adjust the container relative to the sensor in that the adjustment means adjusts the container region relative to a fixed sensor arrangement. The fixed sensor arrangement may be formed, in particular, including multiple sensors which have, e.g., different orientations.

According to a particularly preferred embodiment, the THz sensor puts out non-parallel radiation, in particular, divergent or convergent radiation, i.e. with an opening angle of the beam bundle. Hereby, the emission of divergent radiation, i.e. a cone of rays widening towards the outside, is of particular advantage. The enables the emission of beams leading to a reflection at points of the boundary surfaces that are not in a perpendicular orientation in relation to the optical axis of the THz sensor. Thereby, reflections from various points of the joint can be detected, e.g., even from measuring positions having a smaller angle of incidence where the THz sensor will detect no reflections of the exterior surface. In general, it will not to be possible to directly associate the reflections of the cone of beams with a boundary surface from the individual measurements, where, e.g., even multiple different points of the pinch-off seam may reflect simultaneously. However, the present disclosure recognizes that the large number of measurements at the various positions at different orientations later allows for a secure determination.

According to a preferred embodiment, the determination can be made according to the principle of synthetic radar aperture SAR which is otherwise known from height measurements in aircraft. Such SAR determinations are made, in particular, from flying objects like aircraft or satellites and allows for a two-dimensional imaging of a segment of terrain. The present disclosure recognizes that such an evaluation method, used in terrain measurements by aircraft, in the present case is also advantageous for measuring a pinch-off seam.

Further methods of evaluating the pinch-off seam are neural networks or deep learning, further, artificial intelligence (AI). Hereby, in particular, it is possible to initially carried out measurements of correct pinch-off seams, and further measurements of incorrect pinch-off seams, so that the extensive data sets can be used in a learning process to determine or learn which joints are to be evaluated as correct and as incorrect.

Thus, a container can be measured in that an, e.g., essentially cylindrical, container is first positioned in a receptacle such that its end region lies exposed for being measured, and the measurement is carried out covering the area of the joint in that a THz sensor or multiple THz sensors are guided across the joint in trajectories, in particular, in three dimensions or, respectively, not merely in a single measuring plane, and the so obtained data sets are evaluated so that an evaluation in the form of an error signal as “correct-incorrect” is put out.

Hereby, one or more of the following comparisons may be carried out: comparing the layer thickness of the ripple or of the two ripples with a lower threshold value and/or an upper threshold value,
comparing the layer thickness of the indentation with a lower threshold value,
comparing the indentation layer thickness with a container layer thickness in the region outside the pinch-off seam,
evaluating the joint opening angle or seam angle respectively in relation to a lower threshold value, to detect acute-angled edges formed in-between the ripples that may lead to undue loads.

Thus, it is possible to perform a versatile measurement with little effort, which also can be continuously improved in a self-learning procedure.

The following numbered clauses include embodiments that are contemplated and non-limiting:
Clause 1. THz measuring method for measuring a container (1) with a joint (4), in particular, a blow mold container (2) with a pinch-off seam (4), including at least the following steps:
   positioning a container area (3) made of a material transparent for a THz radiation (19) and having a joint (4), and
   relative adjustment of at least one THz sensor (8) in relation to the container region (3) in multiple positions (Pi) with at least partially different orientations of the optical axis (B) of the THz sensor (8),
   in the multiple positions (Pi), emitting THz radiation (19) as a non-parallel beam bundle (20) from the THz sensor (8) along its optical axis (B) towards the container region (3) and detecting THz radiation (R) partially reflected on the interior surface (17) and the exterior surface (16) of the container area (3) by the THz sensor (8), and creating data sets (di) from the measuring signals (Si) and position data (Pi) with the orientations,
   evaluating the data sets (di), where one or more of the following characteristics of the joint (4) are determined:
a length (L4) of the joint (4) in its longitudinal direction (L),
a width (b4) of the joint (4) in a transverse direction (Q) perpendicular to the longitudinal direction (L),
a layer thickness profile (Sp) of the layer thickness (d) in the longitudinal direction (L) and the transverse direction (Q),
a ripple wall thickness (d14) of one or two ripples (14) formed on an interior surface (17),
a residual wall thickness (d15) in an indentation (15) between two ripples (14),
a joint angle (alpha) of the joint (4) on the interior surface (17) in an indentation (15) between two ripples (14).
Clause 2. THz measuring method according to Clause 1, where at least one of the characteristics determined is compared with a threshold value, the joint (4) is evaluated as correct or incorrect depending on the comparison, and an error signal (F) is put out depending on the evaluation.
Clause 3. THz measuring method according to Clause 2, where one or more of the following comparisons are made and the error signal (F) is put out depending on the comparison:
a comparison of the layer thickness (d14) of the ripple (14) with a lower threshold value and/or an upper threshold value,
a comparison of the layer thickness (d15) of the indentation (15) with a lower threshold value,
a comparison of the layer thickness (d15) of the indentation (15) with the container area wall thickness (d3) outside the joint (4),
a comparison of the joint angle (alpha) with a lower threshold value, to determine acute-angled indentations formed in-between the ripples (14).
Clause 3.1 Measuring method according to one of the Clauses 1 through 2, where a blow mold container (3) is measured as the container, and a pinch-off seam (4), in particular, kissing mouth shaped pinch-off seam (4), is measured as the joint in an end region (3) of the blow mold container (1),
where the pinch-off seam (4) comprises two ripples (14) and an indentation (15) formed in-between the ripples (14) on the interior surface (17) of the end region (3) in its transverse direction.
Clause 4. THz measuring method according to one of the Clauses 1 through 3.1, where, further:
a container area wall thickness (d3) of the container (1) in a container region (3) outside the joint (4) is determined, where
the layer thickness profile (Sp), the ripple wall thickness (d14) and/or the residual wall thickness (d15) are compared with the container area wall thickness (d3).
Clause 5. THz measuring method according to one of the Clauses 1 through 4, where a refraction index (n) of the plastic material of the container (1) is supplementary used when evaluating the characteristics of the joint (4).
Clause 6. Method according to one of the Clauses 1 through 5, where upon evaluating and/or determining one or more of the following methods are used: a synthetic aperture SAR, a neural network, a deep learning method, an artificial intelligence method (AI), a comparison with stored measuring data or correct containers (1).
Clause 7. Method according to one of the Clauses 1 through 6, where the THz sensor (8) is guided along a trajectory (T), in particular, by means of a robotic arm (11), and
carries out measurements continuously or in discrete positions, where in the trajectory (T) various positions (Pi) and the orientation of the THz sensors (8) are adjusted, where the trajectory (T) extends, at least in part:
   three-dimensionally and/or in multiple planes and/or
   not or not exclusively in a spiral course, and/or
   in the transverse direction (Q) perpendicular to the longitudinal direction (L) of the joint (4), and/or
   with orientations of the optical axis (B) towards different points of the container area (3) and/or different axes of the container area (3).
Clause 8. THz measuring method according to one of the Clauses 1 through 7, where the THz measuring device (6) is arranged stationary, and the container (1) is adjusted relative to the THz measuring device by means of an adjustment means.
Clause 9. THz measuring method according to one of the Clauses 1 through 8, where in at least one position (Pi) of the THz sensor (8) reflected beams (R) are picked up
   from different angles relative to the optical axis (B), and/or
   from different areas of the interior surface (17) of the joint (4), and/or
   from a point of the interior surface (17) in the area of the joint (4) without reflected beams on the exterior surface (16)
   from a point of the interior surface (17) in the area of the joint (4) and from the exterior surface (16) outside the joint (4),
      at an orientation of the optical axis (B) of the THz sensor (8) that is not perpendicular to the exterior surface (16) of the container area (3).
Clause 10. Method according to one of the Clauses 1 through 9, where upon evaluating the joint (4) is recognized automatically, in particular, as a profile formed on the interior surface (17) of the container (1) in a transverse direction (Q) with two adjacent ripples (14) and an indentation (15) lying between these two.
Clause 11. Method according to one of the Clauses 1 through 10, where the THz radiation (19) is put out:
   as a time-of-flight measurement, frequency modulated radiation, in particular, FMCW radar radiation, and/or pulsed radiation, and/or
   in a frequency range between 10 GHZ and 50 THz, in particular, 10 GHZ and 10 THZ, in particular, 20 GHz, or between 50 GHz and 5 THz.
Clause 12. THz measuring device (6) for measuring a container (1) with a joint (4), in particular, a blow mold container with a pinch-off seam (4), the THz measuring device (6) comprising:
a THz sensor (8), adapted to emit a non-parallel beam bundle (20) along its optical axis (B), to detect reflected THz radiation (R), and to put out a measuring signal (Si),
an adjustment device (10) for adjusting the at least one THz sensor (8) in pre-defined positions (Pi) and aligning the optical axis (B) relative to a container (1), a controller means (12) adapted to receive the measuring signals (Si) and to create data sets (di) from the measuring signals (Si), position data (di) of the adjustment device (10) and orientation data of the THz sensor (8),
   an evaluation unit (18) adapted to determine one or more of the following characteristics of the joint (4) from the data sets (di):
a length (L4) of the joint (4) in its longitudinal direction L),
a width (b4) of the joint (4) perpendicular to its longitudinal direction (L),
a layer thickness profile (Sp) of the layer thickness (d) in a longitudinal direction (L) of the joint (4) and in a transverse direction perpendicular to the longitudinal direction (L),
a ripple wall thickness (d14) of a Welle (14) of the pinch-off seam (4) formed on an interior surface (17),
a residual wall thickness (d15) in an indentation (15) between the ripples (14),
a joint angle (alpha) of the joint (4) on the interior surface (17) between the ripples (14).
Clause 13. THz measuring device (6) according to Clause 12, where the adjustment device (10) comprises a robotic arm (11), in particular, a multi-articular robot arm (11), which is controlled by the controller means (12) to adjust the at least one THz sensor (8) along a trajectory (T) with different positions (P1) and different orientations.
Clause 14. Method for manufacturing and measuring a blow mold container (1), where
a tube of melt made of a plastic material, e.g., polyamide, is extruded, from the tube of melt a blow mold container (1) with a round bottom area (3) is created in a blow mold process, where a pinch-off seam (4) is formed upon cutting off the tube of melt, and
subsequently, the pinch-off seam (4) is measured using a THz measuring method according to one of the Clauses 1 through 11 and/or a THz measuring device (6) according to Clause 12 or 13, and, depending on the measurement, an error signal (X) is put out if an incorrect pinch-off seam (14) is determined.

### LIST OF REFERENCE NUMERALS

1 container
2 cylindrical a central region
3 end region
4 pinch-off seam in the end region 3
6 THz measuring device
8 THz sensor, radar sensor
10 adjustment means
11 robotic arm as part of the adjustment means 10
12 controller means
14 ripple, elevated material
15 indentation between the ripples 14
16 exterior surface
17 interior surface
18 evaluation unit
19 THz radiation
20 non-parallel beam bundle, in particular, emission cone
22 form closure joint
A axis of symmetry of the container 1
alpha joint angle in the pinch-off seam 4
B optical axis of the THz sensor 8
di data sets
F error signal
Si measuring signal in the position data Pi
SP layer thickness profile
Pi position data of the sensor 8 relative to the container 1
L longitudinal direction of the pinch-off seam 4
Q transverse direction of the pinch-off seam 4
b4 width of the pinch-off seam 4
d3 end region wall thickness of the end region 3
d14 ripple wall thickness
d15 residual wall thickness in the indentation 15
L4 length of the pinch-off seam 4 in the longitudinal direction L

1. A THz measuring method for measuring a container with a joint, including at least the following steps:
positioning a container area made of a material transparent for a THz radiation and having a joint, and
relative adjustment of at least one THz sensor in relation to the container region in multiple positions with at least partially different orientations of the optical axis of the THz sensor,
in the multiple positions, emitting THz radiation as a non-parallel beam bundle from the THz sensor along its optical axis towards the container region and detecting THz radiation partially reflected on the interior surface and the exterior surface of the container area by the THz sensor, and creating data sets from the measuring signals and position data with the orientations,
evaluating the data sets, where one or more of the following characteristics of the joint are determined:
a length of the joint in its longitudinal direction,
a width of the joint in a transverse direction perpendicular to the longitudinal direction,
a layer thickness profile of the layer thickness in the longitudinal direction and the transverse direction,
a ripple wall thickness of one or two ripples formed on an interior surface,
a residual wall thickness in an indentation between two ripples, a joint angle of the joint on the interior surface in an indentation between two ripples.

2. The THz measuring method of claim 1, where a blow form container is measured as the container, and a pinch-off seam is measured as the joint.

3. The THz measuring method of claim 1, where at least one of the characteristics determined is compared with a threshold value, the joint is evaluated as correct or incorrect depending on the comparison, and an error signal is put out depending on the evaluation.

4. The THz measuring method of claim 3, where one or more of the following comparisons are made and the error signal is put out depending on the comparison:
a comparison of the layer thickness of the ripple with a lower threshold value and/or an upper threshold value,
a comparison of the layer thickness of the indentation with a lower threshold value,
a comparison of the layer thickness of the indentation with the container area wall thickness outside the joint,
a comparison of the joint angle with a lower threshold value, to determine acute-angled indentations formed in-between the ripples.

5. The THz measuring method of claim 1, where a blow mold container is measured as the container, and a pinch-off seam, in particular, kissing mouth shaped pinch-off seam, is measured as the joint in an end region of the blow mold container,
where the pinch-off seam comprises two ripples and an indentation formed in-between the ripples on the interior surface of the end region in its transverse direction.

6. The THz measuring method of claim 1, where, further a container area wall thickness of the container in a container region outside the joint is determined, where the layer thickness profile, the ripple wall thickness and/or the residual wall thickness are compared with the container area wall thickness.

7. The THz measuring method of claim 1, where a refraction index of the plastic material of the container is supplementary used when evaluating the characteristics of the joint.

8. The THz measuring method of claim 1, where upon evaluating and/or determining one or more of the following methods are used:
a synthetic aperture SAR, a neural network, a deep learning method, an artificial intelligence method, a comparison with stored measuring data or correct containers.

9. The THz measuring method of claim 1, where the THz sensor is guided along a trajectory, in particular, by means of a robotic arm, and
the THz sensor carries out measurements continuously or in discrete positions, where in the trajectory various positions and the orientation of the THz sensors are adjusted, where the trajectory extends, at least in part:
three-dimensionally and/or in multiple planes and/or
three-dimensionally and/or in multiple planes, and/or
in the transverse direction perpendicular to the longitudinal direction of the joint, and/or
with orientations of the optical axis towards different points of the container area and/or different axes of the container area.

10. The THz measuring method of claim 1, where the THz measuring device is arranged stationary, and the container is adjusted relative to the THz measuring device by means of an adjustment means.

11. The THz measuring method of claim 1, where in at least one position of the THz sensor reflected beams are picked up
from different angles relative to the optical axis, and/or
from different areas of the interior surface of the joint, and/or
from a point of the interior surface in the area of the joint without reflected beams on the exterior surface,
from a point of the interior surface in the area of the joint and from the exterior surface outside the joint,
at an orientation of the optical axis of the THz sensor that is not perpendicular to the exterior surface of the container area.

12. The THz measuring method of claim 1, where upon evaluating the joint is recognized automatically.

13. The THz measuring method of claim 12, where the joint is recognized automatically as a profile formed on the interior surface of the container in a transverse direction with two adjacent ripples and an indentation lying between these two.

14. The THz measuring method of claim 1, where the THz radiation is put out:
as a time-of-flight measurement, frequency modulated radiation, in particular, FMCW radar radiation, and/or pulsed radiation, and/or
in a frequency range between 10 GHZ and 50 THz.

15. A THz measuring device for measuring of a container with a joint, in particular, a blow mold container with a pinch-off seam, the THz measuring device comprising:
a THz sensor configured to emit a non-parallel beam bundle along its optical axis, to detect reflected THz radiation, and to put out a measuring signal, an adjustment device for adjusting the at least one THz sensor in pre-defined positions and aligning the optical axis relative to a container,
a controller means configured to receive the measuring signals and to create data sets from the measuring signals, position data of the adjustment device and orientation data of the THz sensor,
an evaluation unit configured to determine one or more of the following characteristics of the joint from the data sets:
a length of the joint in its longitudinal direction,
a width of the joint perpendicular to its longitudinal direction,
a layer thickness profile of the layer thickness in a longitudinal direction of the joint and in a transverse direction perpendicular to the longitudinal direction,
a ripple wall thickness of a Welle of the pinch-off seam formed on an interior surface,
a residual wall thickness in an indentation between the ripples,
a joint angle of the joint on the interior surface between the ripples.

16. The THz measuring device of claim 15,
where the adjustment device comprises a robotic arm, which is controlled by the controller means to adjust the at least one THz sensor along a trajectory with different positions and different orientations.

17. The THz measuring device of claim 16, where the robotic arm is multi-articular.
